(19) United States
(12) Patent Application Publication
(10) Pub. No.: US 2020/0284086 A1
(43) Pub. Date: Sep. 10, 2020

(54) DOOR FRAME GUARD

(71) Applicant: Bruce VOLPE, El Dorado Hills, CA (US)

(72) Inventor: Bruce VOLPE, El Dorado Hills, CA (US)

(21) Appl. No.: 16/294,024

(22) Filed: Mar. 6, 2019

(51) Int. Cl. E06B 1/34

(52) U.S. Cl. CPC E06B 1/34

(57) ABSTRACT

A door frame guard for protecting doorway frames or door jambs while moving or construction of building interiors is disclosed. An example embodiment includes: an adjustable door frame guard comprising: a first portion having a shell with a front panel integrated with a first side panel, the first side panel being configured with an inward inflection angle; a second portion having a shell with a front panel integrated with a second side panel, the second side panel being configured with an inward inflection angle, the second side panel including at least one notched portion, the first portion and the second portion including interior cushioning attached to the shell; and an adjustment slide adjustably and removably connecting the first portion to the second portion at the front panel with tensioning screws.

### TECHNICAL FIELD

The disclosed subject matter relates to the field of manually operated, door frame protection devices and, in particular, to door frame guards for protecting doorway frames or door jambs while moving or construction of building interiors.

### COPYRIGHT

A portion of the disclosure of this patent document contains material that is subject to copyright protection. The copyright owner has no objection to the facsimile reproduction of the patent document or the patent disclosure, as it appears in the U.S. Patent and Trademark Office patent files or records, but otherwise reserves all copyright rights whatsoever. The following notice applies to the disclosure provided herein and to the drawings that form a part of this document: Copyright 2018-2019, Bruce Volpe; All Rights Reserved.

### BACKGROUND

Furniture or construction materials and equipment may be passed through the door openings defined by doorway frames or door jambs. In many cases, while moving furniture or construction materials through doorways, the door jambs and/or door trim of the finished door frame are struck and damaged by the materials and equipment passing through the door openings. The damaged door jambs and door trim must be repaired with considerable time and expense. The edges of the door jambs and door trim are particularly vulnerable to damage when struck by materials or equipment. In order to protect these edges, some type of guard may be placed over the finished door frame until the moving or construction has been completed. However, conventional protective devices do not lend themselves to temporary installation on a door frame during moving or the construction phase of a building.

### SUMMARY

A door frame guard for protecting doorway frames or door jambs while moving or construction of building interiors is disclosed. It is desirable to provide a door frame guard, which has sufficient stiffness to withstand severe impacts, yet has a capability to resist transmitting the force of these impacts to the edges of door jambs and trim. Additionally, it is desirable to provide a door frame guard, which is inexpensive, may be installed over a door frame easily, can grip the door frame without requiring external fastening devices, may be removed from a door frame easily, and may be reused. An example embodiment as disclosed herein includes: an adjustable door frame guard comprising: a first portion having a shell with a front panel integrated with a first side panel, the first side panel being configured with an inward inflection angle; a second portion having a shell with a front panel integrated with a second side panel, the second side panel being configured with an inward inflection angle, the second side panel including at least one notched portion, the first portion and the second portion including interior cushioning attached to the shell; and an adjustment slide adjustably and removably connecting the first portion to the second portion at the front panel with tensioning screws. The various example embodiments are described in more detail below.

### BRIEF DESCRIPTION OF THE DRAWINGS

Embodiments are illustrated by way of example and not limitation in the figures of the accompanying drawings, in which:

FIG. 1 illustrates a perspective view of the shell portion of a door frame guard of an example embodiment;

FIG. 2 illustrates a side view of the shell portion of a door frame guard of an example embodiment;

FIGS. 3 and 4 illustrate top and bottom views of the shell portion of a door frame guard of example embodiments;

FIGS. 5 and 6 illustrate top and bottom views of a door frame guard of example embodiments showing the shell portion with interior cushioning;

FIG. 7 illustrates a perspective view of a door frame guard of an example embodiment showing the shell portion with interior cushioning;

FIGS. 8 and 9 illustrate perspective views of the interior of a door frame guard of an example embodiment showing the shell portion with interior cushioning;

FIG. 10 illustrates a view of a door frame guard of an example embodiment as attached to a door frame at the hinged side of the doorway from the perspective inside of the doorway;

FIG. 11 illustrates a view of a door frame guard of an example embodiment as attached to a door frame at the hinged side of the doorway from the perspective outside of the doorway;

FIG. 12 illustrates a view of three door frame guards of an example embodiment as attached to a door frame of a doorway from the perspective outside of the doorway; and

FIGS. 13 through 15 illustrate views of an adjustable door frame guard of an example embodiment.

### DETAILED DESCRIPTION

In the following detailed description, reference is made to the accompanying drawings that form a part hereof, and in which are shown, by way of illustration, specific embodiments in which the disclosed subject matter can be practiced. It is understood that other embodiments may be utilized and structural changes may be made without departing from the scope of the disclosed subject matter.

In various example embodiments disclosed herein, a door frame guard is described. In the described example embodiments, the door frame guard provides sufficient stiffness to withstand severe impacts, yet has a cushioning capability to resist transmitting the force of these impacts to the edges of door jambs and trim. Additionally, the door frame guard of the various example embodiments can be inexpensively manufactured. The example door frame guard may be easily installed over a door frame, can grip the door frame without requiring external fastening devices, may be removed from a door frame easily, and may be reused. Additional details of various example embodiments are provided below.

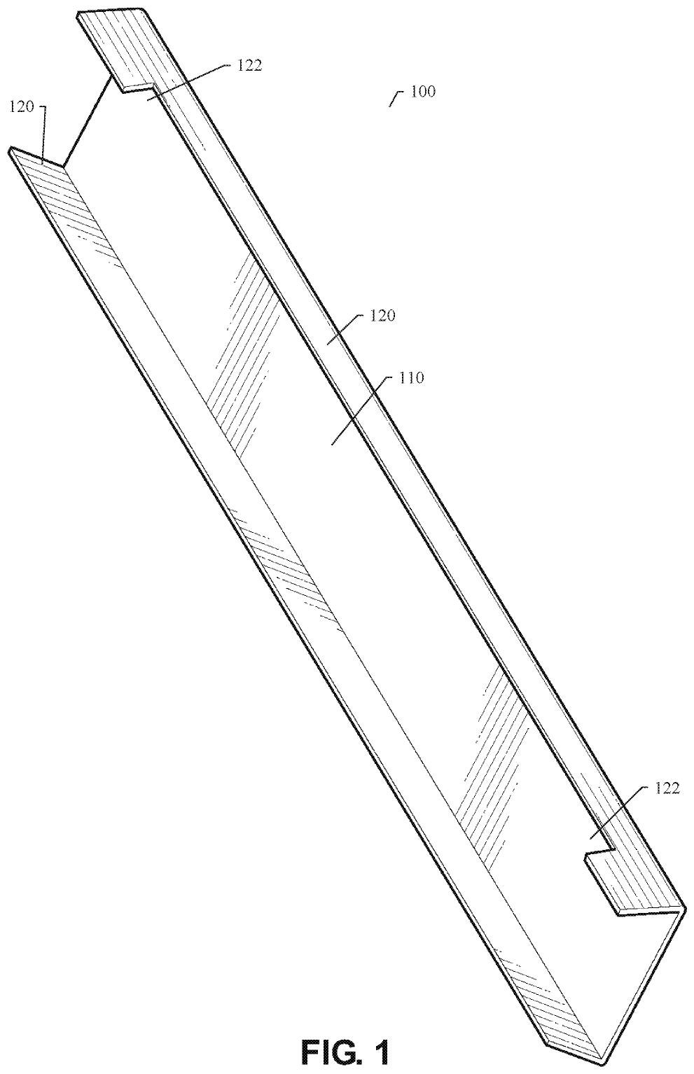

FIG. 1 illustrates a perspective view of the shell portion of a door frame guard 100 of an example embodiment. The shell portion is comprised of a front panel 110 with integrated and angled side panels 120. One or both of the side panels 120 may include one or more notched portions 122 to provide spacing for hinges, latches, or other protruding structures on the door or doorway frame. The side panels 120 are configured with an inward inflection at a pre-defined inflection angle to enable the side panels 120 to apply a force to the sides of the door jamb or doorway trim to removably hold the door frame guard 100 in place. Once in place on a door jamb or doorway trim, the front panel 110 and the side panels 120 of the door frame guard 100 protect the door jamb or doorway trim from impacts from objects moved through the doorway.

In various example embodiments, the shell portion of the door frame guard 100 can be fabricated from a variety of materials including plastic, fiberglass, rubber, metal, or wood. The material used provides a rigid front panel 110, which can withstand forceful impacts as objects are moved through the doorway. However, the material used also provides a level of flex so the door frame side panels 120 can be spread outwardly reducing the inward inflection to enable the side panels 120 to fit over the door jamb or doorway trim. Once the door frame guard 100 is removably installed on the door jamb or doorway trim, the flexible nature of the material used for the door frame guard 100 applies a force to the door jamb or doorway trim to keep the door frame guard 100 in place. As a result, the front panel 110 and side panels 120 of the door frame guard 100 protect the door jamb and doorway trim from impact damage. The length and width of the shell portion of the door frame guard 100 can be varied to accommodate a variety of sizes of doorways, door jambs, trim surfaces, and the like.

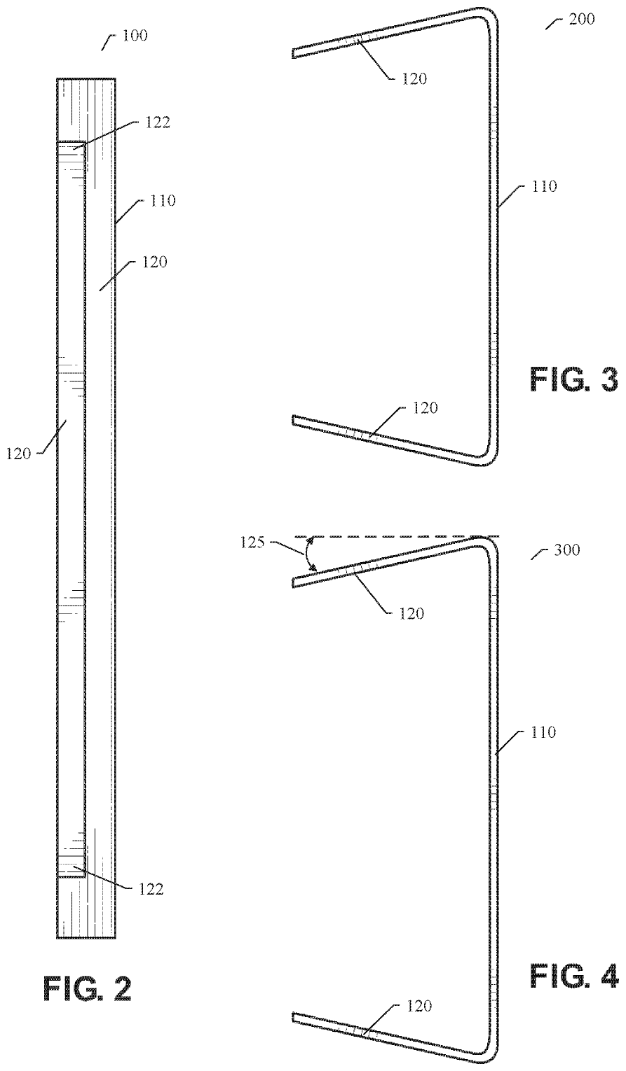

FIG. 2 illustrates a side view of the shell portion of a door frame guard 100 of an example embodiment. As shown, the shell portion of the door frame guard 100 of an example embodiment includes the front panel 110 with integrated and angled side panels 120. One or both of the side panels 120 may include one or a plurality of notched portions 122.

FIGS. 3 and 4 illustrate top and bottom views of the shell portion of an alternative door frame guard 200 and another alternative door frame guard 300 of example embodiments. As shown, the front panel 110 of alternative door frame guard 300 is slightly larger (longer) than the front panel 110 of alternative door frame guard 200 to accommodate a wider door jamb or doorway trim area. FIGS. 3 and 4 also illustrate the inward inflection angle 125 of the side panels 120. The pre-defined inflection angle 125 of the side panels 120 enable the side panels 120 to apply a force to the sides of the door jamb or doorway trim to removably hold the door frame guard 200/300 in place. When the door frame guard 200/300 is to be removably installed onto a door jamb or doorway trim, the door frame side panels 120 can be spread outwardly reducing the inward inflection angle 125 to enable the side panels 120 to fit over the door jamb or doorway trim.

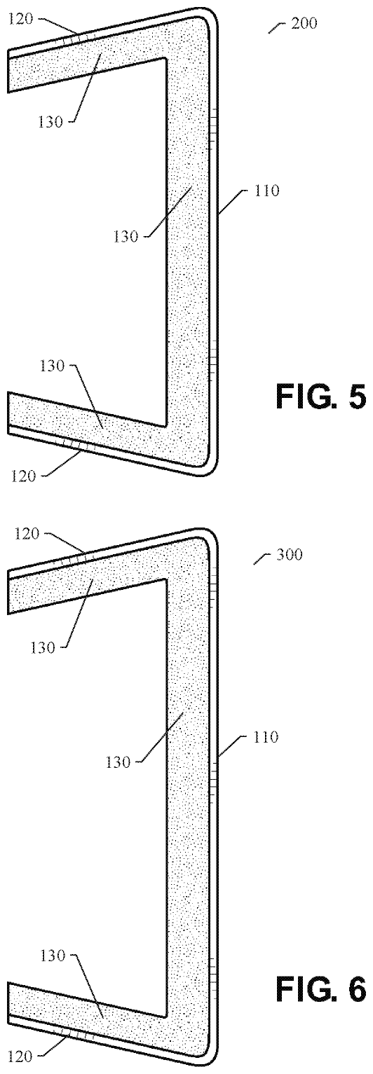

FIGS. 5 and 6 illustrate top and bottom views of door frame guard 200 and door frame guard 300 of example embodiments showing the shell portion with interior cushioning 130. The interior cushioning 130 is provided to further protect the surfaces of the door jamb or doorway trim from damage. The interior cushioning 130 can be fabricated from standard plastic or rubber foam material, fabric, or other soft material, which can be attached to the inner surfaces of the front panel 110 and side panels 120 with an adhesive. The thickness of the interior cushioning 130 can be chosen to provide more or less protection for the surfaces of the door jamb or doorway trim.

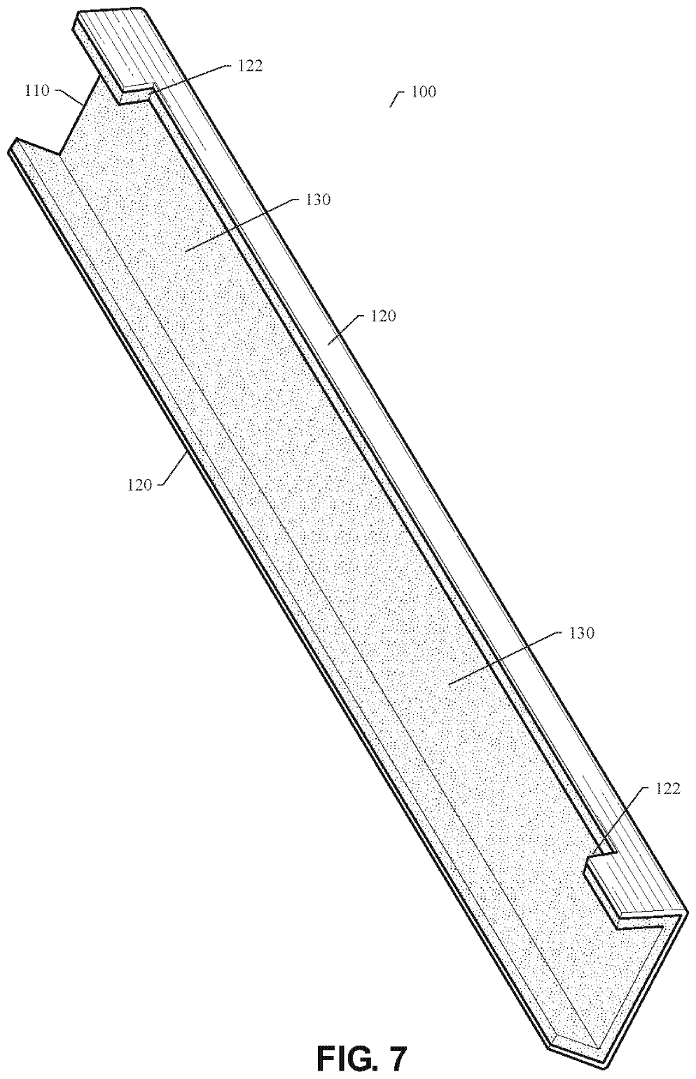

FIG. 7 illustrates a perspective view of a door frame guard 100 of an example embodiment showing the shell portion 110/120 with interior cushioning 130 attached thereto.

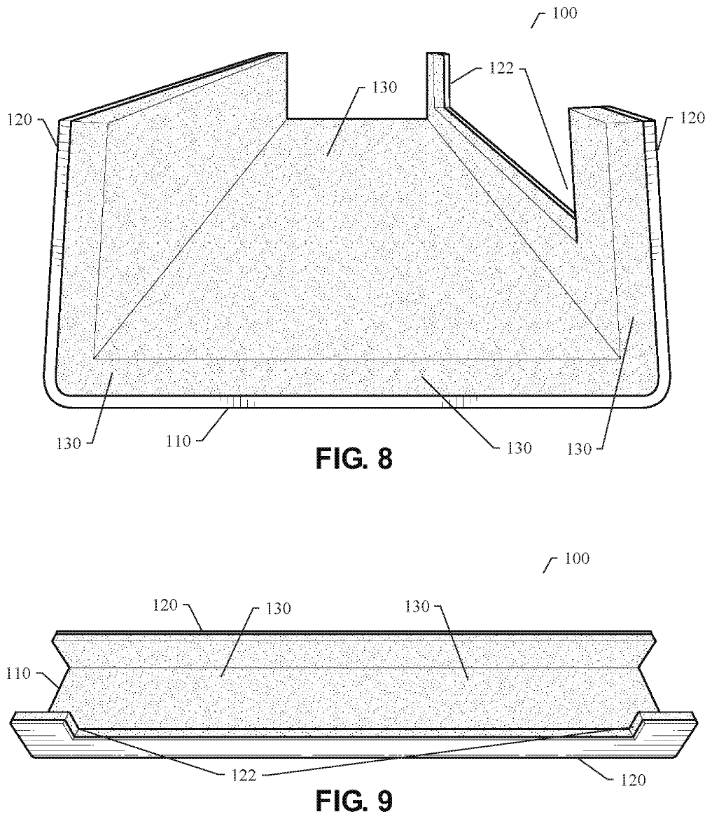

FIGS. 8 and 9 illustrate perspective views of the interior of a door frame guard 100 of an example embodiment showing the shell portion 110/120 with interior cushioning 130 attached thereto. FIGS. 7 through 9 also show the notched portions 122 of the side panels 120.

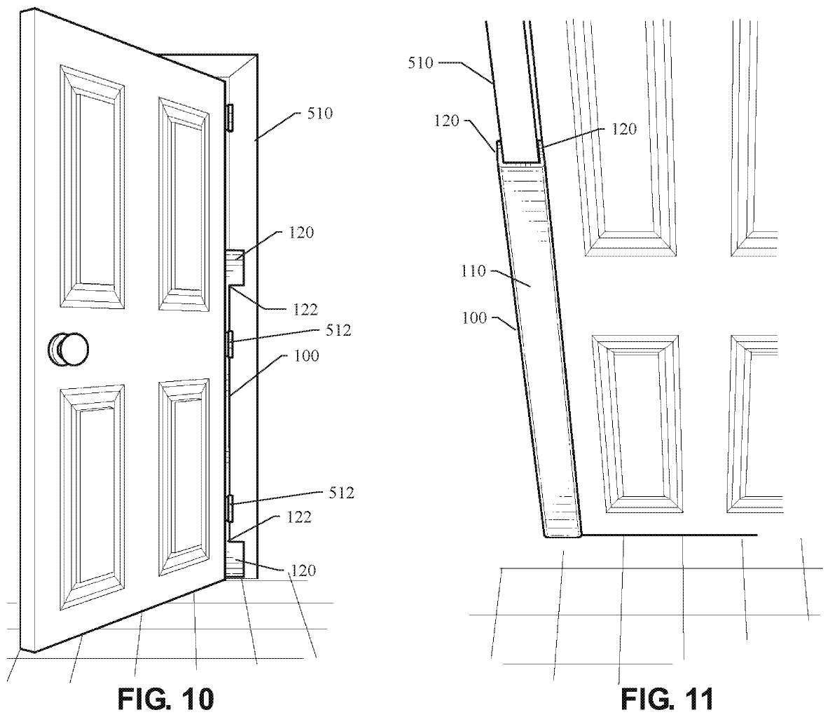

FIG. 10 illustrates a view of a door frame guard 100 of an example embodiment as removably attached to a door frame 510 at the hinged side of the doorway from the perspective inside of the doorway. The door frame guard 100 is shown removably attached to the door frame 510 with the side panels 120 applying a force to the door frame 510 as described above. Because of the notched portions 122 of the side panel 120, the door hinges 512 do not interfere with the ability of the side panels 120 to attach to the door frame 510.

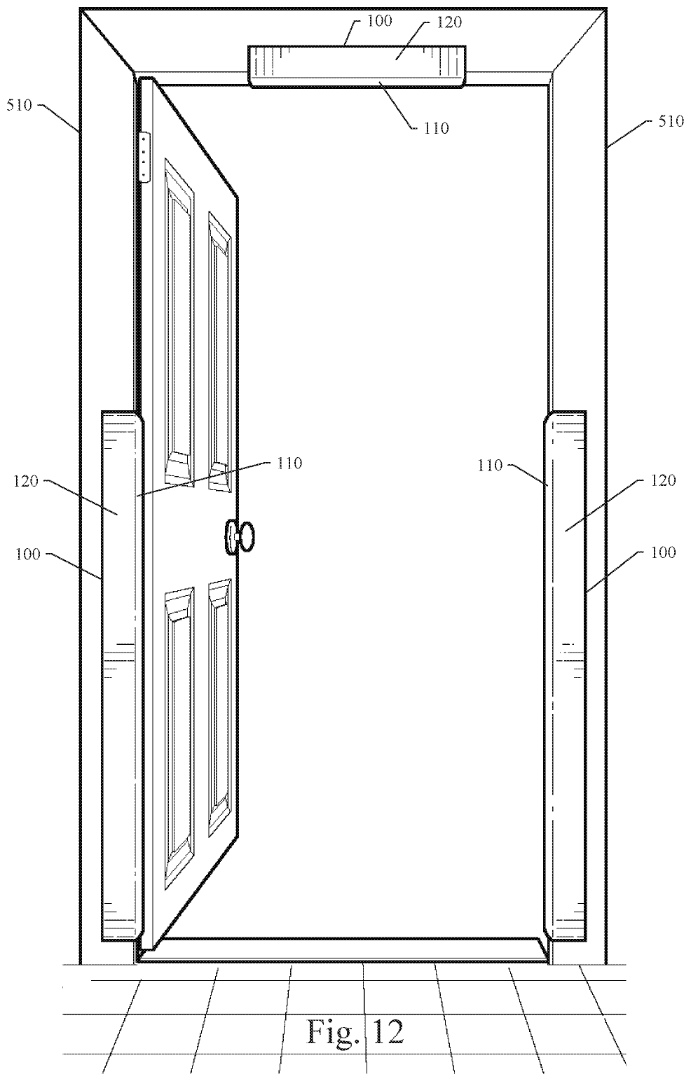

FIG. 11 illustrates a view of the door frame guard 100 shown in FIG. 10 as removably attached to the door frame 510 at the hinged side of the doorway from the perspective outside of the doorway. The front panel 110 and the side panels 120 of the door frame guard 100 serve to protect the door frame 510 from impacts as objects are moved through the doorway.

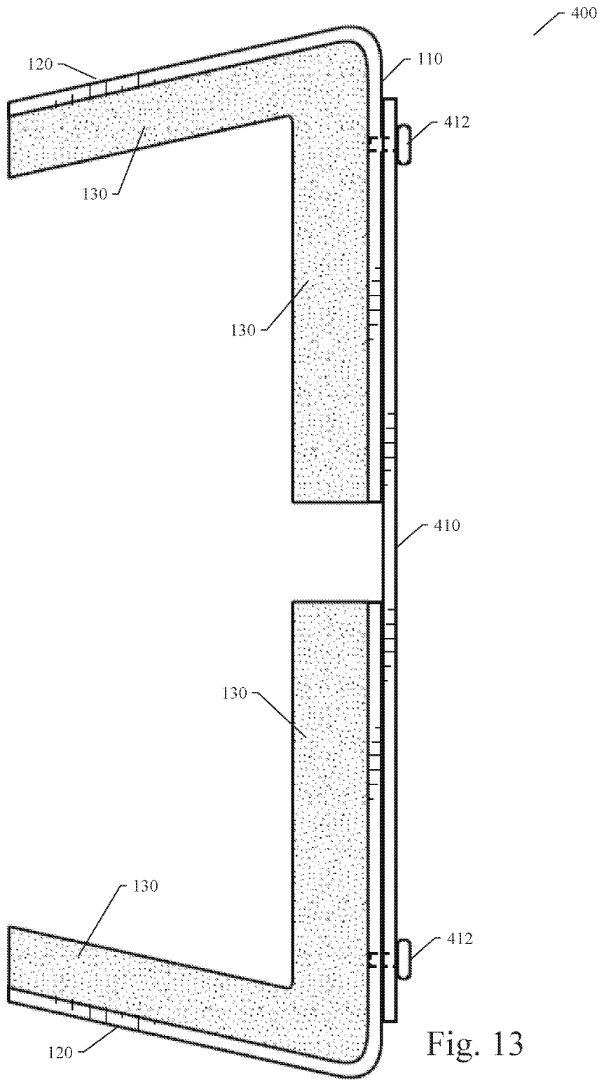

FIG. 12 illustrates a view of three door frame guards 100 of an example embodiment as removably attached to a door frame 510 of a doorway from the perspective outside of the doorway. As described above, the door frame guards 100 are shown removably attached to the door frame 510 with the side panels 120 applying a force to the door frame 510. The front panel 110 and the side panels 120 of the door frame guards 100 serve to protect the door frame 510 from impacts as objects are moved through the doorway.

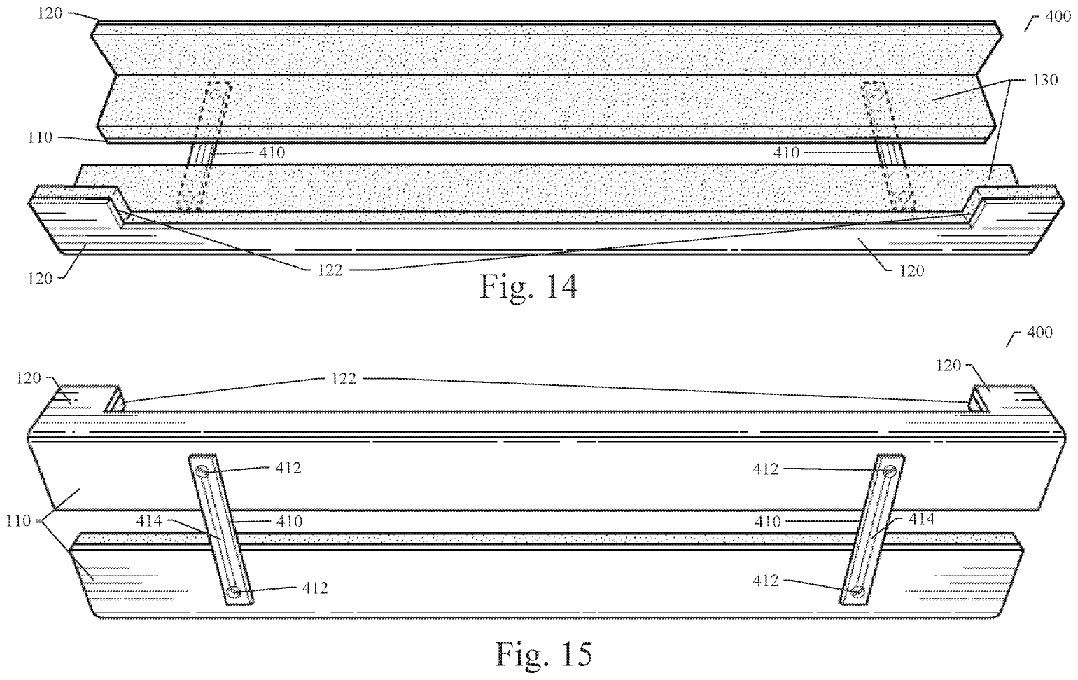

FIGS. 13 through 15 illustrate views of an adjustable door frame guard 400 of an example embodiment. Because the width or thickness of door frames, doorjambs, or doorway trim can substantially vary, the adjustable door frame guard 400 is provided to accommodate a wide variety of door frame sizes. In an example embodiment shown in FIG. 13, the adjustable door frame guard 400 includes a two-piece or two-portion door frame guard, wherein each of the two pieces includes a shell portion with a front panel 110 integrated with a side panel 120. Each piece also includes the interior cushioning 130 to protect the surfaces of the door frame from damage. One or both of the side panels 120 can include one or more notched portions. The two pieces or portions of the adjustable door frame guard 400 are adjustably and removably connected with an adjustment slide 410. The adjustment slide 410 can be attached to the front panel 110 of each piece of the adjustable door frame guard 400 with tensioning screws 412. In one embodiment, the tensioning screws 412 can be tightened into a threaded hole in the front panel 110 of each piece of the adjustable door frame guard 400. As shown in FIG. 15, the adjustment slide 410 includes an opening 414 along the length of the adjustment slide 410 into which the tensioning screws 412 can be inserted at variable positions to capture the adjustment slide 410 between heads of the tensioning screws 412 and the surface of the front panels 110. As a result, the two pieces or portions of the adjustable door frame guard 400 can be separated by an adjustable amount based on the position of the tensioning screws 412 as they are tightened into the adjustment slide 410.

The illustrations of embodiments described herein are intended to provide a general understanding of the structure of various embodiments, and they are not intended to serve as a complete description of all the elements and features of components and systems that might make use of the structures described herein. Many other embodiments will be apparent to those of ordinary skill in the art upon reviewing the description provided herein. Other embodiments may be utilized and derived, such that structural and logical substitutions and changes may be made without departing from the scope of this disclosure. The figures herein are merely representational and may not be drawn to scale. Certain proportions thereof may be exaggerated, while others may be minimized. Accordingly, the specification and drawings are to be regarded in an illustrative rather than a restrictive sense.

The description herein may include terms, such as “up”, “down”, “upper”, “lower”, “first”, “second”, etc. that are used only for descriptive purposes and not to be construed as limiting. The elements, materials, geometries, dimensions, and sequence of operations may all be varied for particular applications. Parts of some embodiments may be included in, or substituted for, those of other embodiments. While the foregoing examples of dimensions and ranges are considered typical, the various embodiments are not limited to such dimensions or ranges.

The Abstract is provided to allow the reader to quickly ascertain the nature and gist of the technical disclosure. The Abstract is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted as reflecting an intention that the claimed embodiments have more features than are expressly recited in each claim. Thus, the following claims are hereby incorporated into the Detailed Description, with each claim standing on its own as a separate embodiment.

As described herein, a door frame guard for protecting doorway frames or door jambs while moving or construction of building interiors is disclosed. Although the disclosed subject matter has been described with reference to several example embodiments, it may be understood that the words that have been used are words of description and illustration, rather than words of limitation. Changes may be made within the purview of the appended claims, as presently stated and as amended, without departing from the scope and spirit of the disclosed subject matter in all its aspects. Although the disclosed subject matter has been described with reference to particular means, materials, and embodiments, the disclosed subject matter is not intended to be limited to the particulars disclosed; rather, the subject matter extends to all functionally equivalent structures, methods, and uses such as are within the scope of the appended claims.

What is claimed is:

1. An adjustable door frame guard comprising:
a first portion having a shell with a front panel integrated with a first side panel, the first side panel being configured with an inward inflection angle;
a second portion having a shell with a front panel integrated with a second side panel, the second side panel being configured with an inward inflection angle, the second side panel including at least one notched portion, the first portion and the second portion including interior cushioning attached to the shell; and
an adjustment slide adjustably and removably connecting the first portion to the second portion at the front panel with tensioning screws.

2. The adjustable door frame guard of claim 1 wherein the shell of the first and second portions is fabricated from a material of a type from the group consisting of: plastic, fiberglass, rubber, metal, and wood.

3. The adjustable door frame guard of claim 1 wherein the interior cushioning of the first and second portions is fabricated from a material of a type from the group consisting of: plastic, rubber, foam, and fabric.

4. The adjustable door frame guard of claim 1 wherein the second side panel including a plurality of notched portions.

5. The adjustable door frame guard of claim 1 wherein the adjustment slide includes an opening along a length of the adjustment slide into which the tensioning screws can be inserted at variable positions to capture the adjustment slide between heads of the tensioning screws and a surface of the front panels of the first and second portions.
